(19) United States
(12) Patent Application Publication
(10) Pub. No.: US 2025/0372738 A1
(43) Pub. Date: Dec. 4, 2025

(54) TEMPERATURE SENSING ASSEMBLY AND BATTERY MODULE INCLUDING THE SAME

(71) Applicant: LG ENERGY SOLUTION, LTD., Seoul (KR)

(72) Inventors: Hyun Jae LEE, Daejeon (KR); In Seop CHOI, Daejeon (KR)

(21) Appl. No.: 18/873,705

(22) PCT Filed: May 4, 2023
(86) PCT No.: PCT/KR2023/006105

§ 371 Date: Dec. 10, 2024

(30) Foreign Application Priority Data
Jun. 10, 2022 (KR) 10-2022-0070939
Apr. 12, 2023 (KR) 10-2023-0048466

(51) Int. Cl. H01M 10/48; H01M 10/42; H01M 50/211; H01M 50/50

(52) U.S. Cl. CPC H01M 10/486; H01M 10/4257; H01M 50/211; H01M 50/50; H01M 2220/20

(57) ABSTRACT

A temperature sensing assembly according to an embodiment of the disclosure may include a substrate; a temperature sensor mounted at the substrate; and a bridge coupled to the substrate and at which a hole facing the temperature sensor is defined. A compression member is disposed between the bridge and the substrate, and is disposed at both sides of the temperature sensor.

### CROSS-REFERENCE TO RELATED APPLICATION

This application is a National Phase entry pursuant to 35 U.S.C. 371 of International Application PCT/KR2023/006105 filed on ______, which claims the benefit of the priority of Korean Patent Application Nos. 10-2022-0070939, filed on Jun. 10, 2022, and 10-2023-0048466, filed on Apr. 12, 2023, which are hereby incorporated by reference in their entirety.

### TECHNICAL FIELD

The present disclosure relates to a temperature sensing assembly for sensing a temperature of a cell stack, and a battery module including the temperature sensing assembly.

### BACKGROUND

In modern society, as portable devices such as mobile phones, notebook computers, camcorders and digital cameras, are daily used, the development of technologies in the fields related to mobile devices as above is actively being carried out. In addition, secondary batteries that are chargeable and dischargeable are used as power sources for electric vehicles (EV), hybrid electric vehicles (HEV), plug-in hybrid electric vehicles (P-HEV) and the like, which are proposed as solutions to solve problems such as air pollution caused by existing gasoline vehicles and the like, using fossil fuel. Therefore, there is an increasing need for development of the secondary batteries.

Currently commercialized secondary batteries include nickel-cadmium batteries, nickel-hydrogen batteries, nickel-zinc batteries, lithium secondary batteries, and the like. Among the secondary batteries, the lithium secondary batteries attract interest due to merits that the lithium secondary batteries are freely chargeable and dischargeable because of having little memory effect compared to nickel-based secondary batteries, and have very low self-discharge rate and high energy density.

In such a lithium secondary battery, a lithium-based oxide and a carbonaceous material are mainly used as a positive electrode active material and a negative electrode active secondary battery material, respectively. The lithium includes an electrode assembly, in which a positive electrode plate and a negative electrode plate that are coated with the positive electrode active material and the negative electrode active material, respectively, are disposed with a separator therebetween, and an exterior material, i.e., a battery case, which seals and accommodates the electrode assembly together with an electrolyte.

In general, according to the shape of the exterior material, the lithium secondary batteries may be classified into a can type secondary battery, in which an electrode assembly is embedded in a metal can, and a pouch type secondary battery in which an electrode assembly is embedded in a pouch made of an aluminum laminate sheet.

In secondary batteries used in small-sized devices, two or three battery cells are disposed, but, in secondary batteries used in medium to large-sized devices such as vehicles, a battery module in which a plurality of battery cells are electrically connected to each other is used.

In this battery module, the plurality of battery cells are connected to each other in parallel or in series to provide a battery cell stack so that capacity and output are improved. Moreover, one or more battery modules may be mounted together with various control and protection systems such as a battery management system (BMS) and cooling system, to provide a battery pack.

When overvoltage, overcurrent, or overheating occurs in the battery cells included in the battery module, this is highly problematic in terms of safety and operational efficiency of the battery module. As an example, when the pressure or temperature of the battery increases, a decomposition reaction of the active material and multiple side reactions proceed, and accordingly, the temperature of the battery rapidly increases. This rapid temperature increase reaccelerates the reaction between the electrolyte and the electrode. Eventually, thermal runaway in which the temperature of the battery rapidly increases occurs, and, when the temperature increases to a certain level or higher, ignition of the battery may occur, and the battery cell and the battery module including the battery cell explode due to the increased internal pressure of the battery.

Accordingly, a means for detecting a change in temperature of the battery cell is required, and thus, a temperature sensor such as a thermistor is disposed in the battery module to check and control an operational state in real time or at fixed intervals.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

An aspect of the present disclosure for solving the above problems is to provide a temperature sensing assembly, which prevents a temperature sensor from being damaged and has improved accuracy and reliability, and a battery module including the temperature sensing assembly.

A temperature sensing assembly according to an embodiment of the present disclosure may include: a substrate; a temperature sensor mounted at the substrate; a bridge coupled to the substrate and at which a hole facing the temperature sensor is defined; and a compression member disposed between the bridge and the substrate, and disposed at both sides of the temperature sensor.

The compression member may surround the temperature sensor and a through-hole may be defined at the compression member, where the through-hole faces the hole defined at the bridge.

The bridge may be coupled at an upper side of the substrate.

The bridge may include: a body part to which the substrate is coupled; and an extension part that extends from the body part, is spaced apart a predetermined distance from the substrate, and is adjacent to the compression member.

A hole may be defined at the extension part.

The substrate may include: a coupling part coupled to the bridge; and a mounting part spaced apart a predetermined distance from the bridge and at which the temperature sensor is mounted.

An adhesive layer may be provided between the coupling part and the bridge.

The substrate may further include an inclined part that connects the coupling part to the mounting part and tilted with respect to the mounting part.

The compression member may be bonded to each of the substrate and the bridge.

The hole may not overlap with the compression member in a penetration direction of the hole.

A battery module according to an embodiment of the present disclosure may include: a housing; a cell stack accommodated at the housing and including a plurality of battery cells; and a temperature sensing assembly that senses a temperature of the cell stack. The temperature sensing assembly may include: a substrate disposed above the cell stack; a temperature sensor mounted at the substrate; a bridge coupled to the substrate and at which a hole facing the temperature sensor is defined; and a compression member disposed between the bridge and the substrate, and disposed at both sides of the temperature sensor.

The battery module may further include a busbar frame at which a busbar coupled to the plurality of battery cells is mounted. The bridge may be pivotably coupled to the busbar frame.

At least a portion of the temperature sensing assembly may be disposed between an upper plate of the housing and the cell stack.

A vehicle according to an embodiment of the present disclosure may include the battery module described above.

According to the preferred embodiments of the present disclosure, even when the cell stack swells, or the pressure is applied to the substrate by the tolerance or the like during the assembling of the battery module, the temperature sensor may be prevented from being damaged by the compression member, and the substrate may be maintained to be in the state of being adjacent to or in close contact with the cell stack.

Accordingly, the accuracy and the reliability of the temperature sensor may be improved.

Moreover, the compression member may not interfere with the temperature sensor and the hole of the bridge may be defined to face the temperature sensor, so that the temperature sensor enters the hole even when the compression member is excessively compressed. Accordingly, the temperature sensor may be prevented from being damaged.

In addition, the effects may be included which are easily predictable by those skilled in the art from the configurations according to the preferred embodiments of the present disclosure.

### BRIEF DESCRIPTION OF THE DRAWINGS

The following drawings attached in this specification illustrate a preferred embodiment of the present disclosure and function to provide further understanding of the technical spirit of the present disclosure along with the detailed description of the disclosure. The present disclosure should not be construed as being limited to only the drawings.

FIG. 1 is a perspective view illustrating an outer appearance of a battery module according to an embodiment of the present disclosure.

FIG. 2 is an exploded perspective view of the battery module illustrated in FIG. 1.

FIG. 3 is a view illustrating a temperature sensing assembly provided in a battery module according to an embodiment of the present disclosure.

FIG. 4 is an exploded perspective view of a temperature sensing assembly according to an embodiment of the present disclosure.

FIG. 5 is a plan view of a temperature sensing assembly according to an embodiment of the present disclosure.

FIG. 6 is a schematic view for explaining an operation of a temperature sensing assembly according to an embodiment of the present disclosure.

FIGS. 7 and 8 are views of a temperature sensing assembly according to Comparative Example.

FIG. 9 is an exploded perspective view of a temperature sensing assembly according to another embodiment of the present disclosure.

### DETAILED DESCRIPTION

Hereinafter, preferred embodiments of the present disclosure will be described in detail with reference to the accompanying drawings to enable those skilled in the art to which the present disclosure pertains to easily carry out the present disclosure. The present disclosure may, however, be embodied in different forms and should not be construed as being limited by the embodiments set forth herein.

The parts unrelated to the description, or the detailed descriptions of related well-known art that may unnecessarily obscure subject matters of the present disclosure, may be omitted in order to clearly describe the present disclosure. Like reference numerals may refer to like elements throughout the whole specification.

Moreover, terms or words used in this specification and claims should not be restrictively interpreted as ordinary meanings or dictionary-based meanings, but should be interpreted as meanings and concepts conforming to the scope of the present disclosure on the basis of the principle that an inventor can properly define the concept of a term to describe and explain his or her disclosure in the best ways.

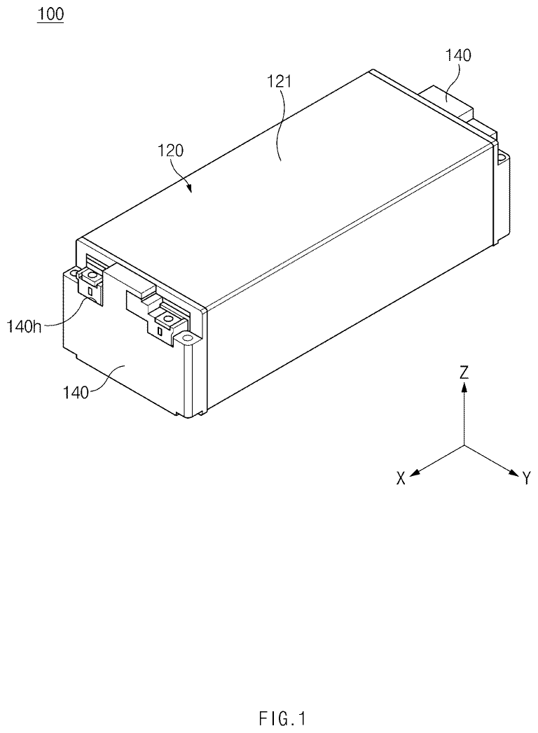

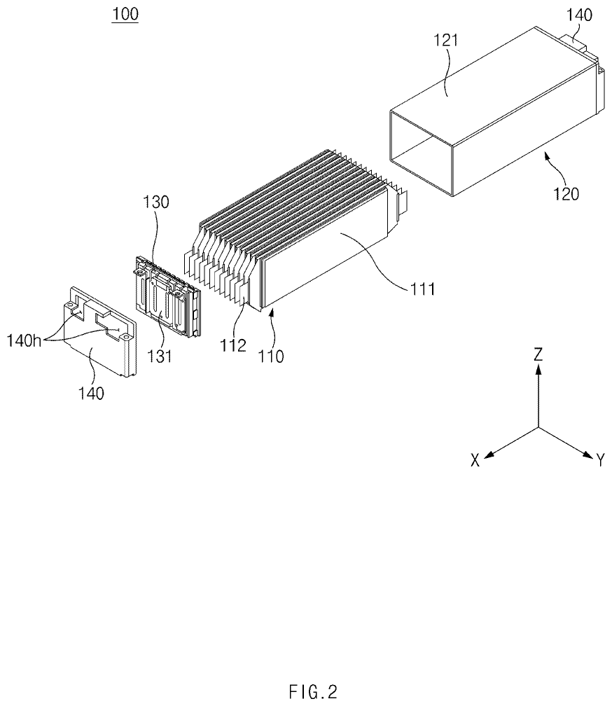

FIG. 1 is a perspective view illustrating an outer appearance of a battery module according to an embodiment of the present disclosure. FIG. 2 is an exploded perspective view of the battery module illustrated in FIG. 1.

A battery module 100 according to an embodiment of the present disclosure may include a cell stack 110 and a housing 120.

The cell stack 110 may include a plurality of battery cells 111 disposed to be parallel to each other. The cell stack 110 may be accommodated in the housing 120.

The plurality of battery cells 111 may be disposed to face each other in a first direction (e.g., a direction parallel to an Y axis). In more detail, the plurality of battery cells 111 may be stacked in the first direction. In addition, each of the battery cells 111 may be disposed to be elongated in a second direction (e.g., a direction parallel to an X axis) perpendicular to the first direction. The first direction may be a direction parallel to a full-width direction of the housing 120, and the second direction may be a direction parallel to a full-length direction of the housing 120.

Each of the battery cells 111 may be a pouch type battery cell. In the pouch type battery cell, the number of stacked battery cells per unit area may be maximized, and thus an energy density of the battery module 100 may increase. The battery cell 111 provided in a pouch type may be manufactured by accommodating an electrode assembly, which includes a positive electrode, a negative electrode, and a separator, in a cell case in which a laminate sheet is molded, and then, thermally fusing and sealing the cell case. However, the battery cell 111 is not necessarily provided in a pouch type, and it is apparent that the battery cell 111 may be provided in a prismatic type, a cylinder type, or other various types under a level at which storage capacity required by a device on which the battery cell 111 is mounted in the future is achieved.

Each of the battery cells 111 may be provided with a pair of electrode leads 112. The pair of electrode leads 112 may protrude at opposite directions, and may protrude to be parallel to a longitudinal direction of the battery cell 111. However, the embodiment of the present disclosure is not limited thereto, and it is also possible that the pair of electrode leads 112 protrude to be parallel to each other in the same direction.

In addition, the cell stack 110 may be provided with at least one heat dissipating pad. The heat dissipating pad may be disposed between the plurality of battery cells 111, or disposed to cover the outermost battery cell 111.

The housing 120 may provide an outer appearance of the battery module 100. The housing 120 may have a metal material having high rigidity.

The housing 120 may have various structures. As one example, the housing 120 may be a mono-frame. The mono-frame may be a metal plate in which an upper plate 121, a lower plate, and a pair of side plates are integrated with each other. As another example, the housing 120 may have a structure in which a U-shaped frame and the upper plate 121 are coupled to each other. The U-shaped frame may be a metal plate in which a lower plate and side plates are coupled to or integrated with each other. In addition, the structure of the housing 120 may be provided as a structure, in which L-shaped frames are coupled to each other. It should be noted that the housing may be provided in various structures that are not described in the foregoing examples.

The housing 120 may have an inner space, and the cell stack 110 may be accommodated in the inner space. In more detail, the housing 120 may include the upper plate 121, the lower plate, and the pair of side plates. In the housing 120, each of both ends in the full-length direction may be opened, and may be covered by an end plate 140 to be described later.

The battery module 100 may further include a busbar frame 130 and the end plate 140.

The busbar frame 130 may be disposed at each of both sides in a full-length direction of the cell stack 110. At least one busbar 131 may be mounted on the busbar frame 130, and each of the busbars 131 may be connected to the electrode leads 112 of the battery cells 111. The busbar 131 may be a component for electrically connecting the plurality of battery cells 111 to an external device.

The end plate 140 may be disposed outside the busbar frame 130. That is, the busbar frame 130 may be disposed between the cell stack 110 and the end plate 140.

The end plate 140 may be coupled to the housing 120. The end plate 140 may cover each of both the opened ends of the housing 120. An opening 140h may be defined in the end plate 140, and an electrical connection of the busbar 131 may be achieved through the opening 140h. That is, the busbar 131 of one battery module 100 may be electrically connected to another battery module 100 or a battery disconnect unit (BDU) through the opening 140h.

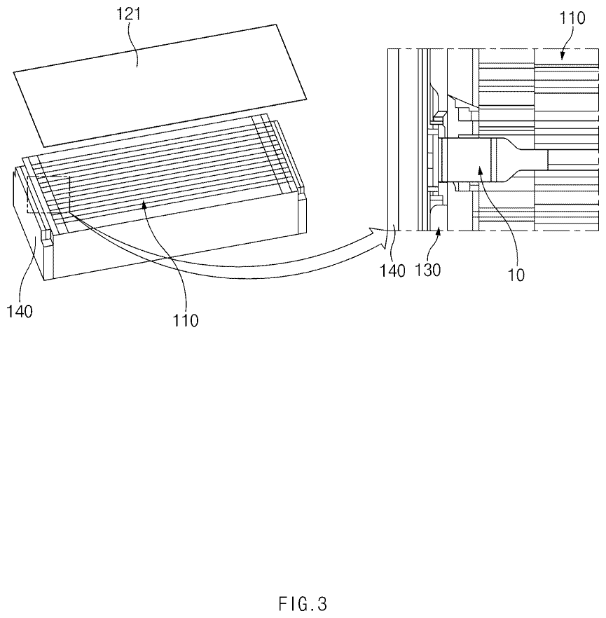

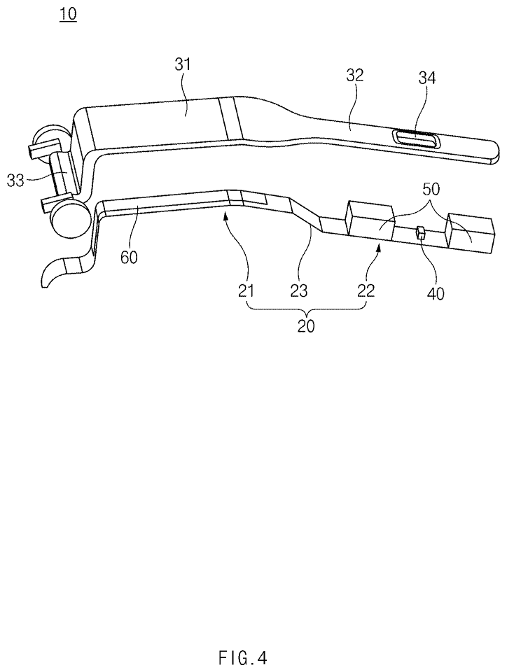

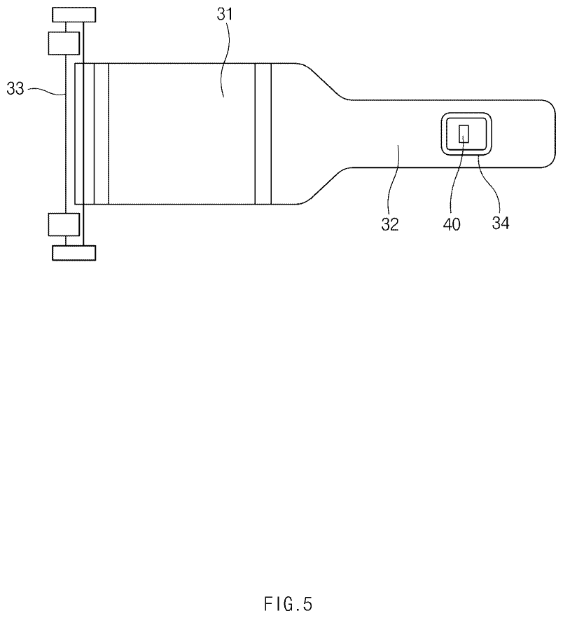

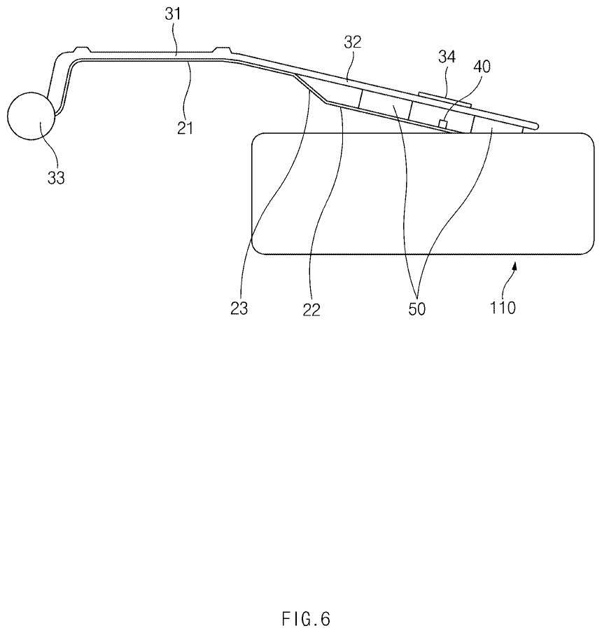

FIG. 3 is a view illustrating a temperature sensing assembly provided in a battery module according to an embodiment of the present disclosure. FIG. 4 is an exploded perspective view of a temperature sensing assembly according to an embodiment of the present disclosure. FIG. 5 is a plan view of a temperature sensing assembly according to an embodiment of the present disclosure. FIG. 6 is a schematic view for explaining an operation of a temperature sensing assembly according to an embodiment of the present disclosure.

The battery module 100 may include a temperature sensing assembly 10 that senses a temperature of the cell stack 110.

At least a portion of the temperature sensing assembly 10 may be disposed between the upper plate 121 of the housing 120 and the cell stack 110. That is, the at least a portion of the temperature sensing assembly 10 may be disposed above the cell stack 110, and may be disposed below the upper plate 121. The temperature sensing assembly 10 may be pressed to or allowed to be in close contact with a side of the cell stack 110 by the upper plate 121 or a separate component disposed at a lower portion of the upper plate 121.

The temperature sensing assembly 10 may be connected to the busbar frame 130. In more detail, the temperature sensing assembly 10 may be pivotably connected to the busbar frame 130. For example, the temperature sensing assembly 10 may be hinge-coupled to the busbar frame 130.

Accordingly, the temperature sensing assembly 10 may be in reliably close contact with the cell stack 110, and may accurately measure the temperature of the cell stack 110.

The temperature sensing assembly 10 may include a substrate 20, a temperature sensor 40 mounted on the substrate 20, a bridge 30, which is coupled to the substrate 20 and in which a hole 34 facing the temperature sensor 40 is defined, and a compression member 50 disposed between the bridge 30 and the substrate 20.

The substrate 20 may be disposed above the cell stack 10. The substrate 20 may be provided to be elongated approximately in the full-length direction of the cell stack 110. The substrate 20 may include a plurality of regions having different tilt angles. The substrate 20 may be provided as one body, but is not limited thereto.

The temperature sensor 40 may be mounted on the substrate 20. The temperature sensor 40 may be a device capable of temperature sensing. The temperature sensor 40 may be fixed onto the substrate 20 by soldering.

The temperature sensor 40 may include a thermistor. The thermistor is a semiconductor device using a phenomenon in which a resistance value varies depending on temperature. There are advantages in that the thermistor is small in size and capable of measuring the temperature despite a rapid change in temperature or a slight change in temperature.

The substrate 20 may be a flexible printed circuit board (FPCB). The substrate 20 may be electrically connected to the temperature sensor 40, and may transmit the temperature information measured by the temperature sensor 40 to the outside.

The temperature information measured by the temperature sensor 40 may be transmitted to another device outside the battery module 100. For example, the temperature information measured by the temperature sensor 40 may be transmitted to a battery management system (BMS) outside the battery module 100 to be used to control the battery module 100.

The bridge 30 may be coupled at an upper side of the substrate 20. The bridge 30 may have higher rigidity than the substrate 20 and support the substrate 20.

The bridge 30 may be provided to be elongated approximately in the full-length direction of the cell stack 110. The bridge 30 may include a plurality of regions having different tilt angles. The bridge 30 may be provided as one body, but is not limited thereto.

The bridge 30 may be pivotably connected to the busbar frame 130. In more detail, the bridge 30 may be hinge-coupled to an upper end of the busbar frame 130 so as to be pivotable with respect to the busbar frame 130. As the bridge 30 is connected to the substrate 20, the bridge 30 may pivot together with the substrate 20. The bridge 30 may pivot around a shaft parallel to a stacking direction of the cell stack 110.

The hole 34 facing the temperature sensor 40 on the substrate 20 may be defined in the bridge 30. Thus, even when the substrate 20 is deformed toward the bridge 30, the temperature sensor 40 may be inserted into the hole 34. That is, the temperature sensor 40 may be prevented from interfering with the bridge 30.

The substrate 20 may include a coupling part 21 coupled to the bridge 30, and a mounting part 22 which is spaced a predetermined distance from the bridge 30 and on which the temperature sensor 40 is mounted. The substrate 20 may further include an inclined part 23 that connects the coupling part 21 to the mounting part 22 and is provided to be tilted with respect to the mounting part 22.

The bridge 30 may include a body part 31 to which the substrate 20 is coupled, and an extension part 32 that extends from the body part 31, is spaced apart a predetermined distance from the substrate 20, and is in contact with the compression member 50. The bridge 30 may further include a connecting part 33 pivotably connected to the busbar frame 130.

The coupling part 21 of the substrate 20 may be bonded to the bridge 30, and may accordingly be simply coupled to the bridge 30. That is, an adhesive layer 60 may be provided between the coupling part 21 and the bridge 30.

The coupling part 21 may be coupled to the body part 31 of the bridge 30. The coupling part 21 of the substrate 20 may be provided to be parallel to the body part 31 of the bridge 30. Thus, the coupling part 21 and the body part 31 may be in close contact with and coupled to each other with the adhesive layer 60 therebetween.

For example, the adhesive layer 60 may be a double-sided tape.

However, the coupling method between the coupling part 21 of the substrate 20 and the body part 31 of the bridge 30 is not limited thereto.

The mounting part 22 of the substrate 20 may be spaced a predetermined distance from the bridge 30. In more detail, the mounting part 22 may be spaced apart a predetermined distance from the extension part 32 of the bridge 30. Due to the distance, the temperature device 40 and the compression member 50 may be disposed between the substrate 20 and the bridge 30.

The extension part 32 of the bridge 30 may extend from the body part 31. The extension part 32 and the body part 31 may be provided to be parallel to each other or to have different tilts.

The mounting part 22 of the substrate 20 may be provided to be parallel to the extension part 32 of the bridge 30. Thus, the distance may be uniformly provided in a longitudinal direction of the mounting part 22.

The temperature sensor 40 may be mounted on the mounting part 22. The temperature sensor 40 may be fixed onto the mounting part 22 by soldering.

The temperature sensor 40 may face the hole 34 defined in the bridge 30. In more detail, the hole 34 facing the temperature sensor 40 may be defined in the extension part 32 of the bridge 30. Thus, even when the mounting part 22 of the substrate 20 is deformed toward the extension part 32 of the bridge 30, the temperature sensor 40 may be inserted into the hole 34. That is, the temperature sensor 40 may be prevented from interfering with the extension part 32 of the bridge 30.

The inclined part 23 of the substrate 20 may be disposed between the coupling part 21 and the mounting part 22, and connect the coupling part 21 to the mounting part 22. The inclined part 23 may be provided integrally with the coupling part 21 and the mounting part 22. An approximate height difference between the coupling part 21 and the mounting part 22 may be achieved due to the inclined part 23. Accordingly, the coupling part 21 may be in close contact with the body part 31 of the bridge 30, and the mounting part 22 may be spaced apart a predetermined distance from the extension part 32 of the bridge 30.

The connecting part 33 of the bridge 30 may have a shape that is bent downward from the body part 31. The connecting part 33 may be pivotably connected to the busbar frame 130.

The compression member 50 may be disposed between the substrate 20 and the bridge 30. The compression member 50 may be disposed between the mounting part 22 of the substrate 20 and the extension part 32 of the bridge 30.

The compression member 50 may be bonded to each of the substrate 20 and the bridge 30. That is, the compression member 50 may have a bottom surface bonded to the mounting part 22 of the substrate 20, and a top surface bonded to the extension part 32 of the bridge 30.

For example, a lower adhesive layer may be provided between the bottom surface of the compression member 50 and a top surface of the mounting part 22, and an upper adhesive layer may be provided between the top surface of the compression member 50 and a bottom surface of the extension part 32. Each of the lower adhesive layer and the upper adhesive layer may be a double-sided tape.

Accordingly, the mounting part 22 of the substrate 20 and the extension part 32 of the bridge 30 may be prevented from being separated or deformed unintentionally.

The compression member 50 may be configured to be compressed when the substrate 20 is deformed toward the bridge 30. The compression member 50 may mitigate the deformation of the substrate 20 and prevent the substrate 20 from interfering with the bridge 30. In addition, the durability of the temperature sensing assembly 10 may be improved due to the compression member 50.

The compression member 50 may be a compression pad of which a material itself has elasticity and which is compressed and deformed. In this case, the material of the compression member 50 is not limited, and the compression member 50 may have a material that is elastically deformed by preset external force. For example, the compression member 50 may have a material such as sponge or polyurethane foam, which is elastically deformed, and may be compressed between the bridge 30 and the substrate 20.

However, an embodiment of the present disclosure is not limited thereto. Like a spring or the like, the compression member 50 may be configured to exhibit elasticity due to its shape.

The compression member 50 may be disposed at both sides of the temperature sensor 40. That is, a portion of the compression member 50 may be disposed at one side of the temperature sensor 40, and the other portion of the compression member 50 may be disposed at the other side of the temperature sensor 40.

For example, the compression member 50 may include a first compression member 50 disposed at one side of the temperature sensor 40, and a second compression member 50 disposed at the other side of the temperature sensor 40.

Accordingly, the compression member 50 may not interfere with the temperature sensor 40, and pressure may be prevented from being applied to the temperature sensor 40 when the compression member 50 is compressed. In more detail, even when the cell stack 110 swells, or a pressure is applied to the substrate 20 by a tolerance or the like during assembling of the battery module 100, the temperature sensor 40 may be prevented from being damaged by the compression member 50, and the substrate 20 may be maintained to be in a state of being adjacent to or in close contact with the cell stack 110. Accordingly, accuracy and reliability of the temperature sensor 40 may be improved.

The hole 34 defined in the bridge 30 may not overlap the compression member 50 in a penetration direction of the hole 34. Accordingly, the compression member 50 may be prevented from blocking the hole 34, and the temperature sensor 40 may face the hole 34 or enter the hole 34 even when the compression member 50 is compressed.

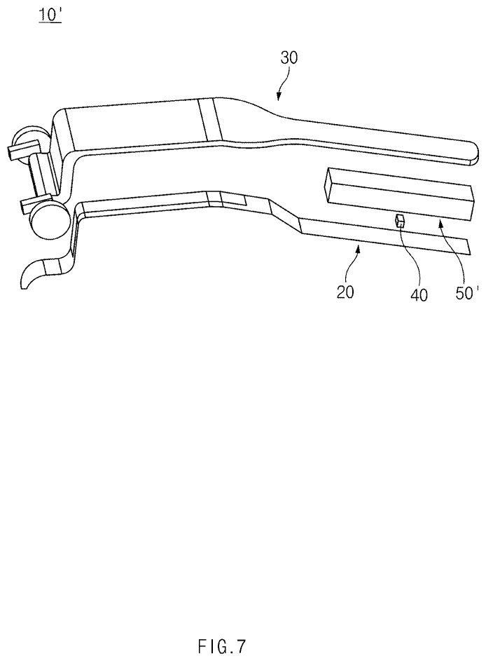

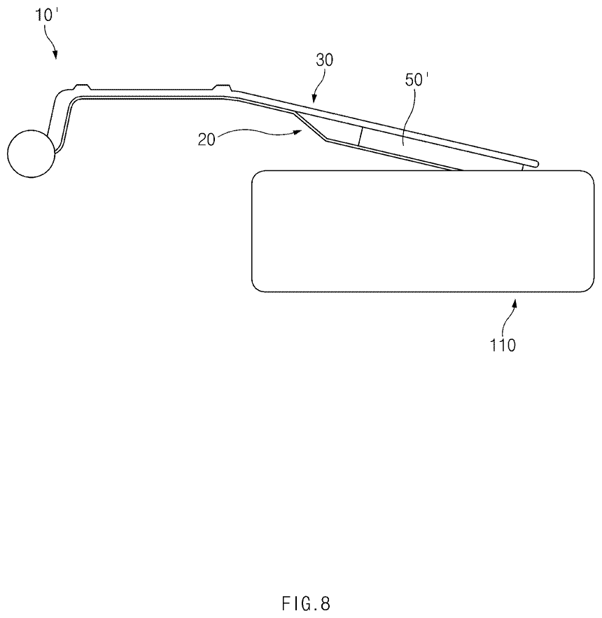

FIGS. 7 and 8 are views of a temperature sensing assembly according to Comparative Example.

In a temperature sensing assembly 10′ according to Comparative Example, a hole facing a temperature sensor 40 may not be defined in a bridge 30, and a compression member 50′ may cover the temperature sensor 40. That is, the temperature sensor 40 may be buried in the compression member 50′.

Thus, there is no problem when the compression member 50′ is slightly compressed, but there is a concern that the temperature sensor 40 may be damaged when the compression member 50′ is tightly compressed.

In contrast, as described above, in the temperature sensing assembly 10 according to the present disclosure, the compression member 50 may not interfere with the temperature sensor 40 and the hole 34 of the bridge 30 may be defined to face the temperature sensor 40, so that the temperature sensor 40 enters the hole 34 even when the compression member 50 is excessively compressed. Accordingly, the temperature sensor 40 may be prevented from being damaged.

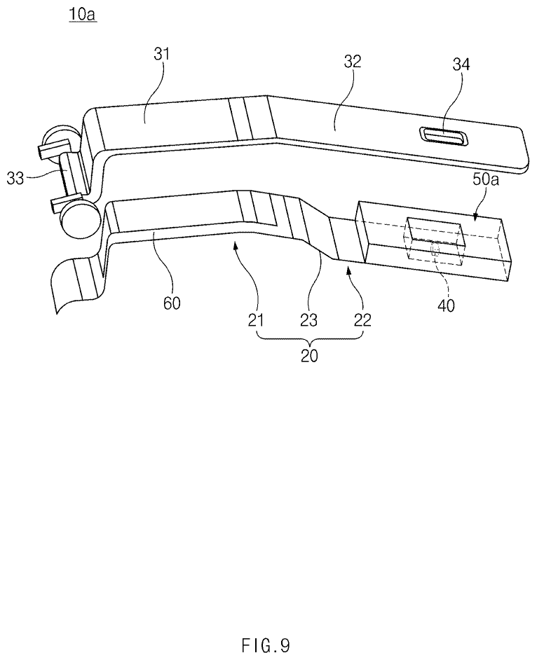

FIG. 9 is an exploded perspective view of a temperature sensing assembly according to another embodiment of the present disclosure.

The description of an embodiment of the present disclosure above applies to a temperature sensing assembly 10′ according to another embodiment of the present disclosure, except for a compression member 50a.

The compression members 50a disposed at both sides of a temperature sensor 40, respectively, may be connected to each other without an interference with the temperature sensor 40. The compression members 50a may be provided as one body.

The compression member 50a may surround the temperature sensor 40. That is, a portion of the compression member 50a may be disposed at one side of the temperature sensor 40, and the other portion of the compression member 50a may be disposed at the other side of the temperature sensor 40.

In more detail, a through-hole may be defined in the compression member 50a, and the temperature sensor 40 may be disposed in the through-hole. The through-hole may face a hole 34 defined in a bridge 30.

This embodiment has an advantage that a process of bonding the compression member 50a to a substrate 20 and/or a bridge 30 is simplified.

The description of the present disclosure is intended to be illustrative, and various changes and modifications can be made by those of ordinary skill in the art to which the present disclosure pertains, without departing from the spirit and scope of the present disclosure as defined by the appended claims.

Therefore, the embodiments set forth herein are to describe the technical spirit of the present disclosure and not to limit. The scope of the technical spirit of the present disclosure is not limited by the embodiments.

Moreover, the protective scope of the present disclosure should be determined by reasonable interpretation of the appended claims and all technical concepts coming within the equivalency range of the present application should be interpreted to be in the scope of the right of the present application.

1. A temperature sensing assembly comprising:
a substrate;
a temperature sensor mounted at the substrate;
a bridge coupled to the substrate and at which a hole facing the temperature sensor is defined; and
a compression member disposed between the bridge and the substrate, and disposed at both sides of the temperature sensor.

2. The temperature sensing assembly of claim 1, wherein the bridge is coupled at an upper side of the substrate.

3. The temperature sensing assembly of claim 1, wherein the bridge comprises:
a body part to which the substrate is coupled; and
an extension part that extends from the body part, is spaced apart a predetermined distance from the substrate, and is adjacent to the compression member.

4. The temperature sensing assembly of claim 3, wherein the hole is defined at the extension part.

5. The temperature sensing assembly of claim 1, wherein the substrate comprises:
a coupling part coupled to the bridge; and
a mounting part spaced apart a predetermined distance from the bridge and at which the temperature sensor is mounted.

6. The temperature sensing assembly of claim 5, wherein an adhesive layer is provided between the coupling part and the bridge.

7. The temperature sensing assembly of claim 5, wherein the substrate further comprises an inclined part connecting the coupling part to the mounting part, and tilted with respect to the mounting part.

8. The temperature sensing assembly of claim 1, wherein the compression member is bonded to each of the substrate and the bridge.

9. The temperature sensing assembly of claim 1, wherein the hole does not overlap with the compression member in a penetration direction of the hole.

10. A battery module comprising:
a housing;
a cell stack accommodated at the housing and comprising a plurality of battery cell; and
a temperature sensing assembly configured to sense a temperature of the cell stack,
wherein the temperature sensing assembly comprises:
a substrate disposed above the cell stack;
a temperature sensor mounted at the substrate;
a bridge coupled to the substrate and at which a hole facing the temperature sensor is defined; and
a compression member disposed between the bridge and the substrate, and disposed at both sides of the temperature sensor.

11. The battery module of claim 10, further comprising a busbar frame at which a busbar coupled to the plurality of battery cells is mounted,
wherein the bridge is pivotably coupled to the busbar frame.

12. The battery module of claim 10, wherein at least a portion of the temperature sensing assembly is disposed between an upper plate of the housing and the cell stack.

13. The temperature sensing assembly of claim 1, wherein the compression member surrounds the temperature sensor and a through-hole defined at the compression member, the through-hole facing the hole defined at the bridge.

14. The battery module of claim 10, wherein the hole does not overlap with the compression member in a penetration direction of the hole.

15. The battery module of claim 10, wherein the compression member surrounds the temperature sensor and a through-hole defined at the compression member, the through-hole facing the hole defined at the bridge.

16. The battery module of claim 10, wherein the bridge comprises:
a body part to which the substrate is coupled; and
an extension part that extends from the body part, is spaced apart a predetermined distance from the substrate, and is adjacent to the compression member.

17. The battery module of claim 16, wherein the hole is defined at the extension part.

18. The battery module of claim 10, wherein the substrate comprises:
a coupling part coupled to the bridge; and
a mounting part spaced apart a predetermined distance from the bridge and at which the temperature sensor is mounted.

19. The battery module of claim 18, the substrate further comprises an inclined part connecting the coupling part to the mounting part, and tilted with respect to the mounting part.

20. A vehicle comprising the battery module of claim 10.
